(19) United States
(12) Patent Application Publication
(10) Pub. No.: US 2025/0376037 A1
(43) Pub. Date: Dec. 11, 2025

(54) ELECTRICAL INTERFACE SYSTEM

(71) Applicant: Caterpillar Inc., Peoria, IL (US)

(72) Inventor: Kurt Lynn WINCKLER, Tucson, AZ (US)

(73) Assignee: Caterpillar Inc., Peoria, IL (US)

(21) Appl. No.: 18/736,832

(22) Filed: Jun. 7, 2024

(51) Int. Cl. B60L 5/38; B60L 5/06

(52) U.S. Cl. CPC B60L 5/38; B60L 5/06; B60L 2200/44

(57) ABSTRACT

A contactor assembly for connecting a mobile machine to a plurality of conductor rails may include a base having a length, a width, and a height, and a top surface, a bottom surface, a first side region, a second side region, and a central region between the first and second side regions. The contactor assembly may further include at least one conductor terminal located in each region of the base, with each conductor terminal including a bottom surface exposed at the bottom surface of the base. The central region may be offset from the first and second side regions along a height direction.

### TECHNICAL FIELD

The present disclosure relates generally to an electrical interface system for a mobile machine and, more specifically, a contactor assembly for connecting a mobile machine to a conductive rail system.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments and/or for variable routes. Further, it can be difficult to properly align and couple such power conducting lines to a machine for proper energy transfer. Such issues can lead to project delays and machine downtime.

A system for providing electric power to a traveling vehicle is described in International Patent App. Pub. No. WO 2020/186296 A1, published on Sep. 24, 2020 (“the '296 publication”). The system described in the '296 publication includes an electrical delivery system at a mine site for a moving vehicle where two electricity conductors are anchored to relocatable roadside barriers. In order to charge the moving vehicle, the delivery system provides an arm extending from the vehicle that aligns with electrical connectors embedded within a horizontal channel of the roadside barriers. While the system described in the '296 publication may be helpful in some circumstances, the interface connecting the roadside conductors to the vehicle may have drawbacks.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a contactor assembly for connecting a mobile machine to a plurality of conductor rails, including a base having a length, a width, and a height, and a top surface, a bottom surface, a first side region, a second side region, and a central region between the first and second side regions. The contactor assembly may further include at least one conductor terminal located in each region of the base, with each conductor terminal including a bottom surface exposed at the bottom surface of the base. The central region is offset from the first and second side regions along a height direction.

In another aspect, the disclosure relates to a contactor assembly for connecting a mobile machine to a plurality of conductor rails, including a base having a length, a width, and a height, and a top surface, a bottom surface, a first side region, a second side region, and a central region between the first and second side regions. The contactor assembly also includes a plurality of conductor terminals located in each region of the base, with each conductor terminal including a bottom surface exposed at the bottom surface of the base. The central region is offset from the first and second side regions along the height direction, and the total width of the contactor assembly is in the range of about 525 mm to about 875 mm.

In another aspect, the disclosure relates to a contactor assembly for connecting a mobile machine to a plurality of conductor rails, including a base having a length, a width, and a height, and a top surface, a bottom surface, a first side region, a second side region, and a central region between the first and second side regions. The contactor assembly further includes an angled transition portion on each side of the central region, the angled transition portions connecting the central region to the first and second side regions. The contactor assembly further includes a plurality of conductor terminals located in each region of the base, with each conductor terminal including a bottom surface exposed at the bottom surface of the base, and a pair of bumpers extending lengthwise along a bottom surface of the angled transition portions. The central region is offset from the first and second side regions along the height direction. The central region is parallel to the first side region and the second side region, and the first side region and second side region are co-planar to one another.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of a mobile machine including a contactor assembly for coupling with a conductive rail system, according to aspects of the present disclosure.

FIG. 2 is a top front-side perspective view of a contactor assembly.

FIG. 3 is a top back-side perspective view of the contactor assembly of FIG. 2, with a portion of the cover removed.

FIG. 4 is a bottom perspective view of the contactor assembly of FIG. 2

FIG. 5 is a cross-sectional view of the contactor assembly of FIG. 2.

FIG. 6 is a cross-sectional view of the contactor assembly, as shown in FIG. 5, where the conductor terminals are in contact with a plurality of conductor rails.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

As used herein, the terms “upstream” and “proximal” are intended to locationally identify components, parts, assemblies, and systems located closer to the frame/body of the mobile machine. Conversely, the terms “downstream” or “distal” are intended to locationally identify components, parts, assemblies, and systems located farther away from the frame/body of the mobile machine.

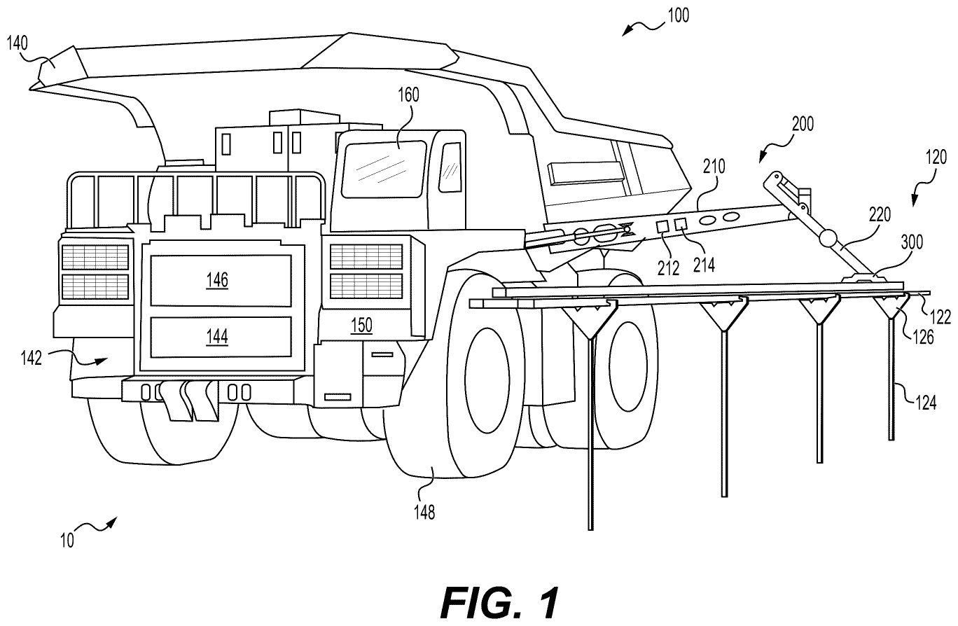

FIG. 1 depicts a mobile machine power system 100 including a mobile machine 140 having an electricity-conducting connector assembly 200, and an electricity-conducting rail system 120 for providing electric power to the mobile machine 140. The mobile machine 140 includes an electric drive system 142 having at least one electric motor 144 and at least one battery system 146. The electric drive system 142 drives a set of ground-engaging elements 148, such as tires or continuous tracks, for propelling and maneuvering the mobile machine 140. The mobile machine 140 also includes a frame/body 150 which supports the mobile machine's mechanical components, including the electricity-conducting connector assembly 200. The mobile machine 140 may include either a hybrid or an all-electric power system, and the electricity-conducting rail system 120 may be applied to either system. The mobile machine 140 and its various systems may be controlled via a machine operator located in the operator cabin 160, or the mobile machine 140 may be semi-or fully-autonomous or remotely operated.

The mobile machine 140 is free-steering, allowing the operator of the machine (or autonomous control system) to freely control the direction and route of the mobile machine 140. Thus, the mobile machine 140 is configured to travel (e.g., in a free-steering manner) selectively along a work route or path within a job site, with the electricity-conducting rail system 120 positioned generally along the route or path. The mobile machine 140 of FIG. 1 is shown in the context of a mining truck, which is commonly used for transporting ore in a mine environment. The present disclosure is not so limited, however, and other types of machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telchandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, or energy storage devices, not shown). The conductor rails 122 may be supported by a plurality of ground-engaging support poles 124 and rail bracket assemblies 126. While FIG. 1 shows an example where the plurality of conductor rails 122 contains three conductor rails, the plurality of conductor rails 122 may contain fewer or more rails. In this example, two of the conductor rails provide electrical power at different polarities (e.g., a conductor rail with a positive polarity and a conductor rail with a negative polarity) while the third conductor rail provides a reference of 0 volts (e.g., a ground rail). The elevated conductor rails 122 may have a height, for example, in the range of about 8 to about 15 feet above the ground 10. In this example, the middle rail of the plurality of conductor rails 122 is at a greater height than the two side rails. Thus, the electricity-conducting rail system does not form a pantograph-type overhead power system, nor an under-machine or low-ground-located power system.

The electricity-conducting connector assembly 200 electrically connects the mobile machine 140 to the electricity-conducting rail system 120. The electricity-conducting connector assembly 200 includes a boom assembly 210 having a proximal end and a distal end; an arm assembly, such as a trailing arm assembly 220, having a proximal end connected to the distal end of the boom assembly 210; and a contactor assembly 300 connected to a distal end of the trailing arm assembly 220. As used herein, the term “trailing” refers to a direction opposite the forward direction of travel of the mobile machine 140. The boom assembly 210 houses a hydraulic system 212 for pivotably extending, retracting, and locking the boom assembly 210, and a pneumatic system 214 for generating and controlling fluid pressure of downstream components (e.g. the trailing arm assembly 220 and the contactor assembly 300), and an integrated busbar (not shown in FIG. 1) for transferring electrical energy along a length of the boom assembly 210. While the disclosure below will provide details of pneumatic system 214, it is understood that the pneumatic system 214 could alternatively be a hydraulic system, and it is further understood that hydraulic system 212 could alternatively be a pneumatic system.

As shown in FIG. 1, the boom assembly 210 extends generally horizontally from a side of the mobile machine and is connected to a side of the frame/body 150 of the mobile machine 140 about a pivot joint (or other relative movement enabling joint configured to enable relative movement between mobile machine 140 and boom assembly 210). The pivot joint is located at a height of approximately over 8 feet on the machine (above the ground 10), or otherwise at a height equal to or above the electricity-conducting rail system 120. The electricity-conducting connector assembly 200 includes several different states of deployment, including an extended state in which the boom assembly 210 is extended generally horizontally outward away from a side of the mobile machine 140 (as shown in FIG. 1), a retracted state (not shown) in which the boom assembly 210 is rotated or pivoted inward to rest against the frame/body 150 of the mobile machine 140 (not shown), and a locked state in which the boom assembly is locked to the side of the frame/body 150 of the mobile machine 140 in the retracted state by a hydraulically-actuated locking pin (not shown). The boom assembly 210 may be engaged or disengaged from the electricity-conducting rails system 120 by the operator, remotely, or autonomously via an engagement or disengagement procedure, or automatically by the mobile machine 140. While the boom assembly 210 is shown to be attached to a mining truck, the same boom assembly 210 is capable of being coupled to various types of mobile machines 140 by use of an interchangeable adapter (not shown) that is specific to the type of machine being operated.

The trailing arm assembly 220 forms a mechanical and electrical connection between boom assembly 210 and contactor assembly 300, and may include one or more arms. The one or more arms may be extendable and retractable (e.g., pneumatically, hydraulically, or mechanically) and may have multiple degrees of freedom to allow for vertical and lateral pivoting about the boom assembly 210.

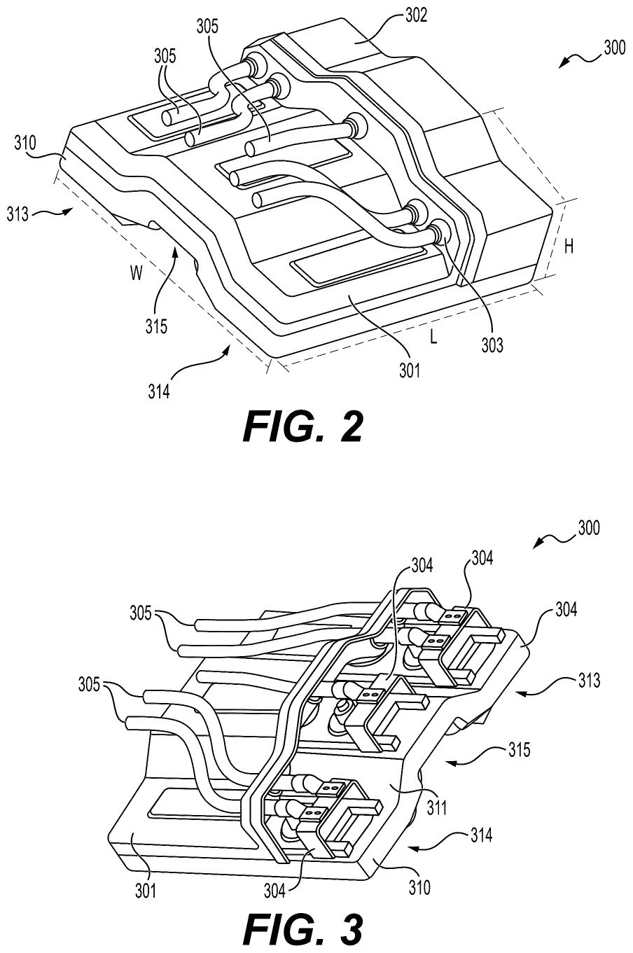

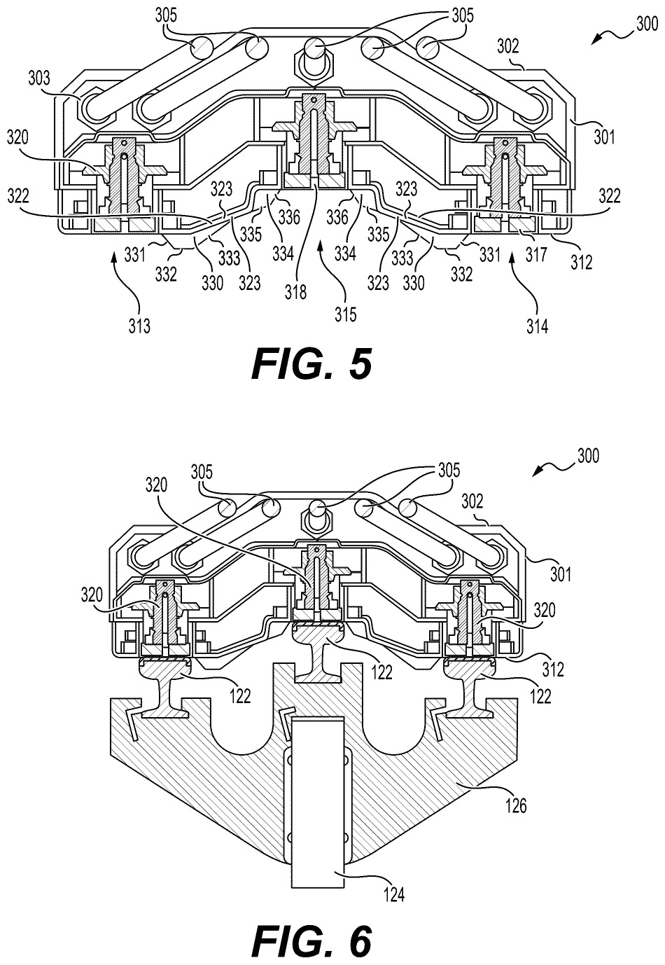

Referring now to FIGS. 2-6, the contactor assembly 300 is configured to interface with the electricity-conducting rail system 120 and includes a base 310 and a plurality of conductor terminals 320 (FIG. 5). The base 310 may be made of any material known in the art. For example, the base may be made of multiple layers of a resin-reinforced material or fabric, such as fiberglass or other electrically-insulating materials. The base may be formed using various composite fabrication techniques, such as vacuum-assisted resin transfer molding, in order to develop a composite structure that is lightweight and substantially rigid.

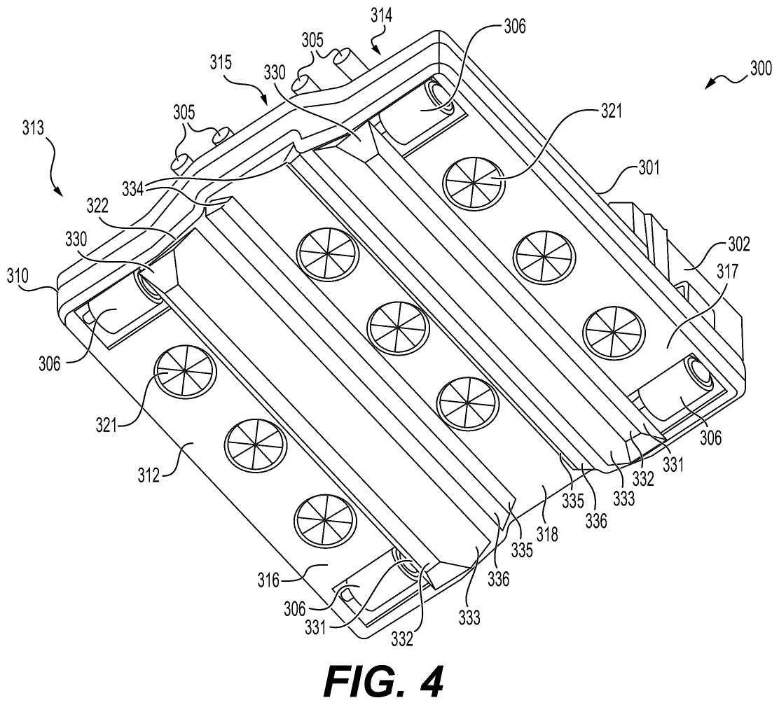

The base 310 may generally have a top surface 311 (FIG. 3) and a bottom surface 312 (FIG. 4) opposite the top surface 311. The contactor assembly 300 may also include a cover 301 that generally encloses the top surface 311 of the base 310, the cover 301 having a removable portion 302 (FIG. 2), as discussed in further detail herein. In some embodiments, the bottom surface 312 of the base 310 may have a plurality of openings or annular recesses. The base 310 may be fully enclosed but for the recesses and openings within the bottom surfaces 312. These openings may serve multiple functions including, but not limited to, facilitating air flow, dissipating heat during operation, or accommodating additional components or attachments.

As shown in FIG. 2, the base 310 may include a length L, a height H (e.g., a height extending from the bottom surface 312 to a top of removable portion 302 of cover 301 while the removable portion 302 is coupled to the base 310), and a width W. The length L, height H, and width W of the base 310 may be reduced relative to prior connecting assemblies such that a lower profile is achieved. For example, the length L may be decreased by about 1% to about 5%, or by about 2.5% to about 3.5% relative to prior connecting assemblies. In addition, the height H may be decreased by about 10% to about 50%, or by about 20% to about 50%, or about 30% to about 40%, or about 35% relative to prior connecting assemblies. Additionally, the width W may be decreased by about 30% to about 60%, or by about 35% to about 55%, or about 40% to about 50%, or about 45%, or about 50% relative to prior connecting assemblies. Each of the length L or the width W of the contactor assembly 300 may range from about 500 mm to about 900 mm; from about 525 mm to about 900 mm; from about 550 mm to about 900 mm; from about 575 mm to about 900 mm; from about 600 mm to about 900 mm; from about 625 mm to about 900 mm; from about 650 mm to about 900 mm; from about 500 mm to about 875 mm; from about 525 mm to about 875 mm; from about 550 mm to about 875 mm; from about 575 mm to about 875 mm; from about 600 mm to about 875 mm; from about 625 mm to about 875 mm; from about 650 mm to about 875 mm; from about 500 mm to about 850 mm; from about 525 mm to about 850 mm; from about 550 mm to about 850 mm; from about 575 mm to about 850 mm; from about 600 mm to about 850 mm; from about 625 mm to about 850 mm; from about 650 mm to about 850 mm; from about 500 mm to about 825 mm; from about 525 mm to about 825 mm; from about 550 mm to about 825 mm; from about 575 mm to about 825 mm; from about 600 mm to about 825 mm; from about 625 mm to about 825 mm; from about 650 mm to about 825 mm; from about 500 mm to about 800 mm; from about 525 mm to about 800 mm; from about 550 mm to about 800 mm; from about 575 mm to about 800 mm; from about 600 mm to about 800 mm; from about 625 mm to about 800 mm; from about 650 mm to about 800 mm; from about 700 mm to about 750 mm; about 690 mm; about 700 mm; about 710 mm; about 720 mm; about 730 mm; about 740 mm; or about 750 mm. It is understood that the length L or height W may have varying dimensions. For example in some arrangements, the length L may be about 730 mm while the width W may be about 700 mm.

The height H of the contactor assembly 300 may range from about 200 mm to 400 mm; from about 225 mm to about 400 mm; from about 250 mm to about 400 mm; from about 275 mm to about 400 mm; from about 300 mm to about 400 mm; from about 325 mm to about 400 mm; from about 200 mm to 375 mm; from about 225 mm to about 375 mm; from about 250 mm to about 375 mm; from about 275 mm to about 375 mm; from about 300 mm to about 375 mm; from about 325 mm to about 375 mm; from about 200 mm to 350 mm; from about 225 mm to about 350 mm; from about 250 mm to about 350 mm; from about 275 mm to about 350 mm; from about 300 mm to about 350 mm; from about 325 mm to about 350 mm; about 300 mm; about 301 mm, about 310 mm; about 320 mm; about 330 mm; about 340 mm; or about 350 mm.

The ratio of the length L to the width W of the contactor assembly 300 is generally about 1:1, forming a generally square shape. The ratio of the length L or width W to the height H of the contactor assembly 300 is generally about 1:2 to about 1:2.5, forming a generally rectangular shape.

The base 310 may be generally separated into regions. For example, the base 310 may be separated into a first side region 313, a second side region 314, and a central region 315 between the first and second side regions 313, 314. The first and second side regions 313, 314 may be co-planar to one another such that a bottom surface 316 of the first side region 313 is on a substantially similar plane as a bottom surface 317 of the second side region 314. The central region 315 may be parallel to the first and second side regions 313, 314 and be offset from the first and second side regions 313, 314 along a height H direction. For example, as shown in FIGS. 3 and 4, a bottom surface 318 of the central region 315, may extend along a plane parallel to the plane along which the bottom surface 316 and the bottom surface 317 extend. A distance between the bottom surface 318 and the bottom surfaces 316, 317 in the height direction may range from about 20 mm to about 150 mm; or from about 50 mm to about 100 mm. In such a manner, the base 310 may have a generally stepped cross-sectional shape. Such a raised central region 315 or otherwise stepped shape may prevent alignment or the forming of an electrical connection between a positively or negatively charged rail 122 with a conductor terminal 320 of central region 315 (e.g., avoiding connection of ground to a charged rail).

Turning now to FIGS. 5 and 6, an angled transition portion 322 having a bottom surface 323 may connect the first and second side regions 313, 314 to the central region 315. The combined width of the central region 315 and the angled transition portions 322 are configured to allow case of placement of the contactor assembly 300 on the plurality of conductor rails 122. For example, the combined width of the central region 315 and the angled transition portions 322 may provide a wider window or opening (relative to prior conducting assemblies) to permit an operator to place the contactor assembly 300, including the conductor terminals 320, into alignment with conductor rails 122. The combined width of the central region 315 and the angled transition is in the range from about 250 mm to about 410 mm; from about 275 mm to about 410 mm; from about 300 mm to about 410 mm; from about 325 mm to about 410 mm; from about 250 mm to about 390 mm; from about 275 mm to about 390 mm; from about 300 mm to about 390 mm; from about 325 mm to about 390 mm; from about 250 mm to about 370 mm; from about 275 mm to about 370 mm; from about 300 mm to about 370 mm; from about 325 mm to about 370 mm; from about 250 mm to about 350 mm; from about 275 mm to about 350 mm; from about 300 mm to about 350 mm; from about 325 mm to about 350 mm; from about 325 mm to about 340 mm; about 300 mm; about 310 mm; about 320 mm; about 330 mm; about 340 mm; or about 350 mm.

As noted herein, the contactor assembly 300 may include the cover 301 that generally encloses the top surface 311 of the base 310. In some embodiments, the cover 301 has a removable portion 302. In a preferred embodiment, the removable portion 302 of the cover 301 may be positioned at a lengthwise end of the base 310 to provide access to the plurality of conductor terminals 320 or a plurality of busbars 304. The cover 301 may include a step region between the removable portion 302 of the cover 301 and a non-removable portion of the cover 301. The cover 301 may include a wire junction portion 303 to allow externals wiring 305 to couple to the plurality of conductor terminals 320 or plurality of busbars 304. In some embodiments, the step region may include the wire junction portion 303.

Referring now to FIG. 4, the contactor assembly 300 may include a multitude of attachments. For example, the contactor assembly 300 may include a plurality of support rollers 306 and a pair of bumpers 330. The plurality of support rollers 306 may generally aid the base 310 in sliding along the plurality of conductor rails 122. The plurality of support rollers may be attached to the first and second side regions 313, 314 of the base 310. In some embodiments, the support rollers 306 may be partially enclosed within the base 310 or substantially enclosed within the base 310. While four support rollers 306 are shown, the disclosure is not so limited. Rather, three or fewer or five or more support rollers 306 are contemplated. Such support rollers 306 may be symmetrically or asymmetrically disposed along the first and second side regions 313, 314 of the base 310.

The pair of bumpers 330 may generally extend from the bottom surface 312 of the base 310 in a spaced configuration to align with gaps between the plurality of conductor rails 122. In such an arrangement, the pair of bumpers 330 limit lateral movement of the base 310 relative to the plurality of conductor rails 122 so as to prevent misalignment of the base 310 and conductor rails 122. In some embodiments, the pair of bumpers 330 may extend lengthwise along the bottom surface 323 of the angled transition portions 322. The pair of bumpers 330 may vary in size and shape based on the characteristics of the base 310 and in accordance with the spacing of the plurality of conductor rails 122. For example, the pair of bumpers 330 may each include a plurality of planar surfaces 331, 332, 333. For example, the pair of bumpers 330 may each include three planar surfaces including two angled side planar surfaces 331, 333, and a central planar surface 332 that is parallel to the bottom surface 312 of the base 310.

In certain embodiments, the contactor assembly 300 may include a first pair of bumpers 330 and a second pair of bumpers 334. The second pair of bumpers 334 may extend lengthwise along the bottom surface 318 of the central region 315 and include two angled side planar surfaces 335, 336. In some embodiments, the pair of bumpers 330, 334 may form a portion the bottom surface 323 of the angled transition portions 322.

Referring now to FIGS. 4-6, the contactor assembly 300 includes a plurality of conductor terminals 320. Each of the plurality of conductor terminals 320 are connected to a busbar 304 extending lengthwise along the top surface 311 of each of the first side region 313, second side region 314, and central region 315, and each busbar 304 is electrically connected to the plurality of conductor terminals 320 of the respective region. The base 310 may comprise a plurality of openings exposing a bottom surface 321 of the plurality of conductor terminals 320. The conductor terminal 320 may be positioned such that the bottom surfaces 321 are exposed. For example, the bottom surfaces 321 may be aligned with the bottom surface 312 of the base 310, or the bottom surfaces 321 may extend (e.g., protrude) past the bottom surface 312 of the base 310. As exemplified in FIG. 4, the conductor terminals 320 may be arranged in a three-by-three matrix, such that there are three groups of linearly-aligned conductor terminals 320, with each group located in the first side region 313, second side region 314, and central region 315, respectively. However, more or less conducting terminals 320 may be used, such as only three, six, or twelve conducting terminals 320. When in the operating state, the bottom surface 321 of the plurality of conductor terminals 320 may be exposed or otherwise extend from the base 310 to slide along the top surface of the plurality of conductor rails 122 to collect electrical energy.

### INDUSTRIAL APPLICABILITY

The disclosed aspects of the contactor assembly 300 above can be used for electrically connecting to an electricity-conducting rail system 120, the contactor assembly 300 sliding along the electricity-conducting rail system 120 for charging a free-steering mobile machine while operating on a worksite, and the contactor assembly 300 disengaging from the electricity-conducting rail system 120. For example, the drawings generally depict the contactor assembly 300, located at a distal end of an electricity-conducting connector assembly 200, including a plurality of conducting terminals 320 for collecting electrical energy retained within a base 310.

In order to operate the mobile machine 140, the mobile machine is controlled by an operator in the operator cabin 160, remotely, or autonomously. Upon approaching the electricity-conducting rail system 120, the electricity-conducting connector assembly 200, including a boom assembly 210, a trailing arm assembly 220, and the contactor assembly 300 is deployed and attached to a plurality of conductor rails 122, as shown in FIG. 1. The contactor assembly 300 is attached to the plurality of conductor rails 122 in two ways. First, the base 310 of the contactor assembly 300 includes a plurality of magnets (not shown) that generate an attractive magnetic force towards the plurality of conductor rails 122. The plurality of magnets may be electromagnets, permanent magnets, or a combination thereof. Additionally, a mass of the contactor assembly 300 generates a gravitational force of mass, which also encourages engagement of the contactor assembly with the plurality of conductor rails 122. While the attractive magnetic force and the gravitation force of mass aid in attaching the contactor assembly 300 to the plurality of conductor rails 122, the contactor assembly 300 also includes a plurality of rail interface features for maintaining its connection with the rails, as discussed above.

While in this engaged state, the bottom surface 321 of the plurality of conductor terminals 320 are exposed or otherwise partially extended from a fully retracted state, and slide along the conductor rails 122 and transfer electrical energy from the conductor rails 122 to the mobile machine 140. Each row of the plurality of conductor terminals 320 electrically connect to an individual conductor rail 122 forming a positive electrical connection, negative electrical connection, and a neutral or ground connection. To help properly connect and maintain connection with the conductor rails 122, the contactor assembly 300 may use one or more pairs of bumpers 330, 334 and a plurality of support rollers 306.

During the connection in the engaged state, electrical energy from the plurality of conductor rails 122 travels through the bottom surface 321 of the plurality of conductor terminals 320 to each of the busbar 304, which are connected to the upstream components of the electricity-conducting connector assembly 200 (e.g., the trailing arm assembly 220 and the boom assembly 210).

Once a disengagement procedure has been initiated by the operator, the contactor assembly 300 may disengage from the plurality of conductor rails 122 and the electricity-conducting connector assembly 200 may then complete the disengagement routine or attempt to reconnect with the plurality of conductor rails 122 to continuing charging the mobile machine 140.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A contactor assembly for connecting a mobile machine to a plurality of conductor rails, comprising:
a base having a length, a width, and a height, and a top surface, a bottom surface, a first side region, a second side region, and a central region between the first and second side regions; and
at least one conductor terminal located in each region of the base, with each conductor terminal including a bottom surface exposed at the bottom surface of the base; and
wherein the central region is offset from the first and second side regions along a height direction.

2. The contactor assembly of claim 1, wherein the first side region and second side region are co-planar to one another.

3. The contactor assembly of claim 2, wherein the central region is parallel to the first side region and the second side region.

4. The contactor assembly of claim 1, further including an angled transition portion on each side of the central region, the angled transition portions connecting the central region to the first and second side regions.

5. The contactor assembly of claim 4, further including a pair of bumpers extending lengthwise along a bottom surface of the angled transition portions.

6. The contactor assembly of claim 1, wherein each region of the base includes a plurality of conductor terminals aligned lengthwise along the respective region.

7. The contactor assembly of claim 6, further including a plurality of busbars, each busbar extending lengthwise along the top surface of a respective one of the first side region, second side region, and central region, and each busbar being electrically connected to the plurality of conductor terminals of the respective region.

8. The contactor assembly of claim 7, further including a cover enclosing the top surface of the base.

9. The contactor assembly of claim 8, wherein the cover includes a removable portion at a lengthwise end of the base, the removable portion covering a wire junction portion connecting the plurality of busbars to external wiring.

10. The contactor assembly of claim 1, further including a plurality of support rollers partially enclosed within the base.

11. The contactor assembly of claim 1, wherein the ratio of the length of the contactor assembly to the width of the contactor assembly is about 1:1.

12. A contactor assembly for connecting a mobile machine to a plurality of conductor rails, comprising:
a base having a length, a width, and a height, and a top surface, a bottom surface, a first side region, a second side region, and a central region between the first and second side regions; and
a plurality of conductor terminals located in each region of the base, with each conductor terminal including a bottom surface exposed at the bottom surface of the base;
wherein the central region is offset from the first and second side regions along the height direction; and
wherein the total width of the contactor assembly is in the range of about 525 mm to about 875 mm.

13. The contactor assembly of claim 12, wherein the first side region and second side region are co-planar to one another.

14. The contactor assembly of claim 13, wherein the central region is parallel to the first side region and the second side region.

15. The contactor assembly of claim 12, wherein the maximum height of the contactor assembly is in the range of about 225 mm to about 375 mm.

16. The contactor assembly of claim 12, further including an angled transition portion on each side of the central region, the angled transition portions connecting the central region to the first and second side regions; and
wherein the combined width of the central region and the angled transitions portions is in the range of about 250 mm to about 410 mm.

17. The contactor assembly of claim 12, wherein the ratio of the length of the contactor assembly to the width of the contactor assembly is about 1:1.

18. A contactor assembly for connecting a mobile machine to a plurality of conductor rails, comprising:
a base having a length, a width, and a height, and a top surface, a bottom surface, a first side region, a second side region, and a central region between the first and second side regions;
an angled transition portion on each side of the central region, the angled transition portions connecting the central region to the first and second side regions;
a plurality of conductor terminals located in each region of the base, with each conductor terminal including a bottom surface exposed at the bottom surface of the base; and
a pair of bumpers extending lengthwise along a bottom surface of the angled transition portions;
wherein the central region is offset from the first and second side regions along the height direction, the central region is parallel to the first side region and the second side region, and the first side region and second side region are co-planar to one another.

19. The contactor assembly of claim 18, wherein the pair of bumpers each include two angled side planar surfaces and a central planar surface that is parallel to the bottom surface of the first and second side regions of the base.

20. The contactor assembly of claim 19, wherein the pair of bumpers are a first pair of bumpers, and the contactor assembly includes a second pair of bumpers extending lengthwise along a bottom surface of the central region.
